(19) United States
(12) Patent Application Publication
(10) Pub. No.: US 2004/0194818 A1
(43) Pub. Date: Oct. 7, 2004

(54) Hydrophilic components for a spin-rinse-dryer

(76) Inventors: James W. Fronsdahl, San Ramon, CA (US); Svetlana Sherman, San Jose, CA (US)

Correspondence Address: DUGAN & DUGAN, PC, 55 SOUTH BROADWAY, TARRYTOWN, NY, 10591, US

(21) Appl. No.: 10/627,197

(22) Filed: Jul. 25, 2003

Related U.S. Application Data
(60) Provisional application No. 60/398,997, filed on Jul. 26, 2002.

(51) Int. Cl. B08B 3/00

(52) U.S. Cl. 134/182; 134/200; 29/428

(57) ABSTRACT

A spin-rinse-dryer (SRD) includes a substrate support adapted to hold and rotate a substrate, and a source of fluid adapted to supply fluid to the surface of a substrate positioned on the substrate support. The SRD also includes at least one shield positioned to receive fluid displaced from a substrate rotating on the substrate support. The shield includes a substrate-facing surface that has been particle-blasted to cause the substrate-facing surface to have a hydrophilic characteristic.

### CROSS-REFERENCE TO RELATED APPLICATIONS

This application claims priority from U.S. Provisional Application Serial No. 60/398,997, filed Jul. 26, 2002, which is related to commonly-owned co-pending U.S. patent application Ser. No. 09/544,660, filed Apr. 6, 2000, and entitled “Spin-Rinse-Dryer”, which claims priority from U.S. Provisional Application Serial No. 60/128,257, filed Apr. 8, 1999. All of the above-referenced patent applications are hereby incorporated by reference herein in their entirety.

### FIELD OF THE INVENTION

The present invention is concerned with spin-rinse-dryers used for rinsing and drying semiconductor substrates.

### BACKGROUND OF THE INVENTION

It is known to employ a spin-rinse-dryer (SRD), to dry a semiconductor substrate, such as a silicon wafer, after the substrate has been subjected to a rinsing process. Drying by means of an SRD may prevent streaking, spotting or the deposit of residue on the surface of the substrate.

In the above-referenced co-pending '660 patent application, an SRD is disclosed in which a substrate is supported in a vertical orientation while being rinsed and spin-dried. The SRD disclosed in the '660 patent application includes a system of shields arranged around the rotated substrate to direct away from the substrate fluid that has been spun off the substrate. It is proposed in the '660 patent application that the shields, or at least a substrate facing surface thereof, be formed of a hydrophilic material such as quartz to prevent droplets from forming and dripping on the semiconductor substrate positioned therebelow. For the same purpose, the top of the housing of the SRD disclosed in the '660 patent application is sloped and hydrophilic.

The present inventors now propose a cost-effective manner of providing the shields, the top and/or an upper door of the SRD housing with suitable hydrophilic surfaces.

### SUMMARY OF THE INVENTION

According to a first aspect of the invention, an SRD includes a substrate support adapted to hold and rotate a substrate, and a source of fluid adapted to supply fluid to the surface of a substrate positioned on the substrate support. The inventive SRD also includes a shield positioned to receive fluid displaced from a substrate rotating on the substrate support, and comprising a substrate-facing surface that has been particle-blasted.

As used herein and in the appended claims, the term “particle-blasted” shall be understood to include one or more of grit-blasted, sand-blasted, bead-blasted and the like.

According to a second aspect of the invention, a vertical SRD includes a substrate support adapted to hold and rotate a vertically oriented substrate, and a source of fluid adapted to supply fluid to the surface of a substrate positioned on the substrate support. The inventive vertical SRD according to the second aspect of the invention also includes either a single shield or a shield system comprising a plurality of vertically and horizontally staggered shields positioned to receive fluid flung from a substrate rotating on the substrate support. At least one and preferably each of the shields has a substrate-facing surface that has been particle-blasted.

According to a third aspect of the invention, a vertical SRD includes a substrate support adapted to hold and rotate a vertically oriented substrate and a source of fluid adapted to supply fluid to the surface of a substrate positioned on the substrate support. The inventive vertical SRD according to the third aspect of the invention further includes a housing which encloses the substrate support. The housing has a top portion that has a slope adapted to cause fluid to flow therealong away from a region above the substrate support. The top portion has a lower surface that has been particle-blasted. In each of the above aspects the particle blasted surface may further include surface features which increase the area of the particle-blasted surface and which may also form channels for directing fluid in a desired direction so as to avoid fluid drops from impacting the substrate.

According to a fourth aspect of the invention, a method of fabricating an SRD shield is provided. The inventive method includes forming a shield adapted to fit in an SRD housing and having a substrate facing surface adapted to receive fluid displaced from a substrate held and rotated in the housing. The inventive method further includes particle-blasting the substrate facing surface of the shield and may include forming surface features therein that increase surface area, or forming channels therein for directing fluid in a desired direction so as to avoid fluid drops from impacting the substrate.

The particle-blasting of a substrate-facing surface or surfaces of a shield or shields for an SRD, as provided for by the present invention, may impart a hydrophilic characteristic to the substrate-facing surface or surfaces or may increase the hydrophilic characteristic of an already hydrophilic surface.

Other features and advantages of the present invention will become more fully apparent from the following detailed description of the preferred embodiments, the appended claims and the accompanying drawings.

### BRIEF DESCRIPTION OF THE DRAWINGS

FIG. 1 is a perspective view of an SRD in which the present invention may be applied;

FIG. 2 is a side cross-sectional view of the SRD of FIG. 1;

FIG. 3 is a side cross-sectional view of a shield system that is part of the SRD of FIG. 1 and in which the present invention may be applied;

FIG. 4 is a front cross-sectional view of the SRD of FIG. 1;

FIG. 5 is a partial isometric view of a shield that may be provided in accordance with a further aspect of the invention; and

FIG. 6 is a partial cross-sectional view of the shield of FIG. 5;

### DETAILED DESCRIPTION

In a vertical SRD, a system of one or more shields is employed to receive fluid thrown off by a substrate which is rinsed and spun within the SRD. At least part of the substrate-facing surfaces of the shields have a particle-blasted finish. Preferably the particle-blasted finish is sufficient so as to exhibit a hydrophilic characteristic or to increase the hydrophilic characteristic of an already hydrophilic surface. The hydrophilic characteristic is desirable to deter formation of fluid drops that might fall on the substrate. The particle-blasted finish may be applied to the inner surface of a sloping top of the SRD which may in one aspect include a moveable door.

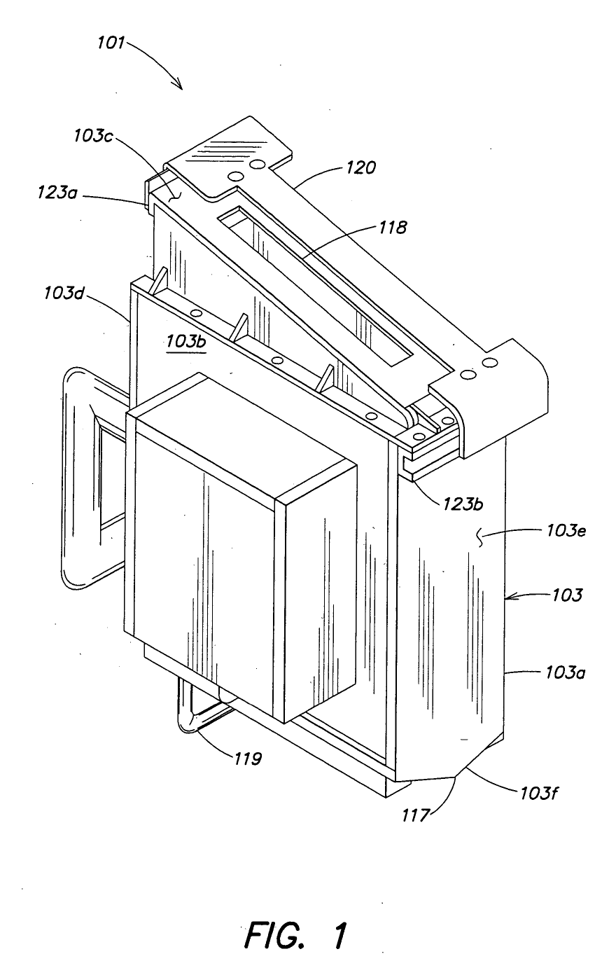

Certain aspects of an exemplary SRD will now be described with reference to FIGS. 1-4. Although the SRD of FIGS. 1-4 is adapted for processing vertically oriented substrates, it should be noted that the invention also may be employed in SRD's that process substrates in other orientations.

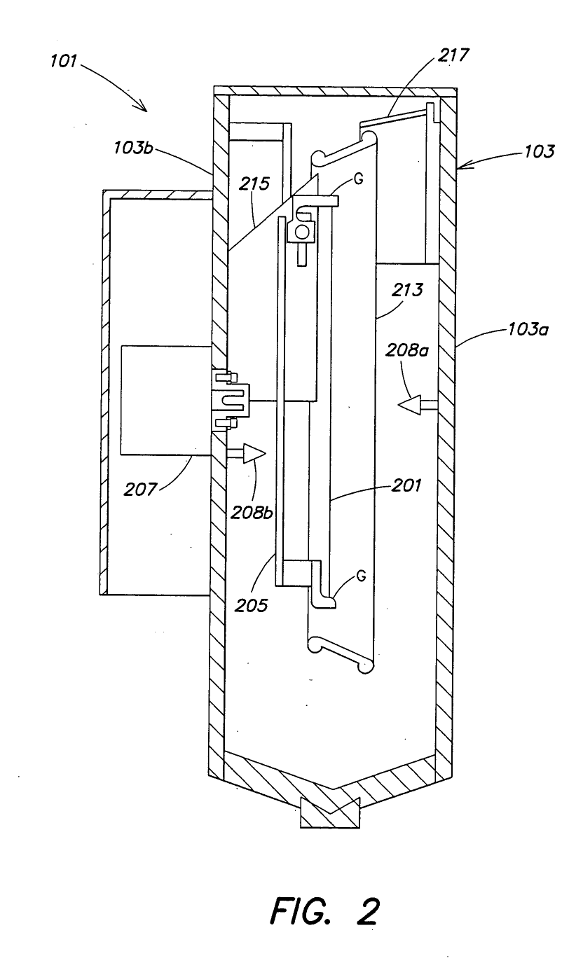

Referring initially to FIG. 1, reference numeral 101 generally indicates an SRD. The SRD 101 includes a housing 103. The housing 103 has a front side 103a (FIG. 2), a back side 103b, a top 103c, a first side wall 103d, and a second side wall 103e. In the example shown, the top 103c of the SRD housing 103 slopes down from the first side wall 103d to the second side wall 103e so that any fluid which collects on the top 103c will tend to flow to the lower side of the top 103c and down the second side wall 103e. It will be apparent that the top of the SRD housing may be sloped in other directions so that fluid will flow away from the region directly above a substrate being processed therebelow.

The top 103c of the SRD housing 103 has an opening 118 sized to allow substrate insertion and extraction. A slidable door 120 may be mounted on a pair of tracks 123a, 123b so as to slide back and forth to open and close the opening 118. A bottom wall 103f of the SRD housing 103 may slope to a low point 117. A drain 119 may be coupled to the bottom wall 103f at the low point 117 to remove rinsing fluid from the SRD housing 103.

Aspects of the internal structure of the SRD 101 will now be described with reference to FIG. 2. In FIG. 2, a substrate 201 is shown supported within the SRD 101 in a vertical orientation by a pair of grippers G which extend from a rotatable flywheel 205. The flywheel 205 may be coupled to a motor 207 via an opening in the back side 103b of the SRD housing 103. A pair of rinsing fluid nozzles 208a and 208b are coupled to a source of rinsing fluid (not shown), and are positioned to supply rinsing fluid to the front and back surfaces of the substrate 201, respectively, (e.g., to the centers thereof).

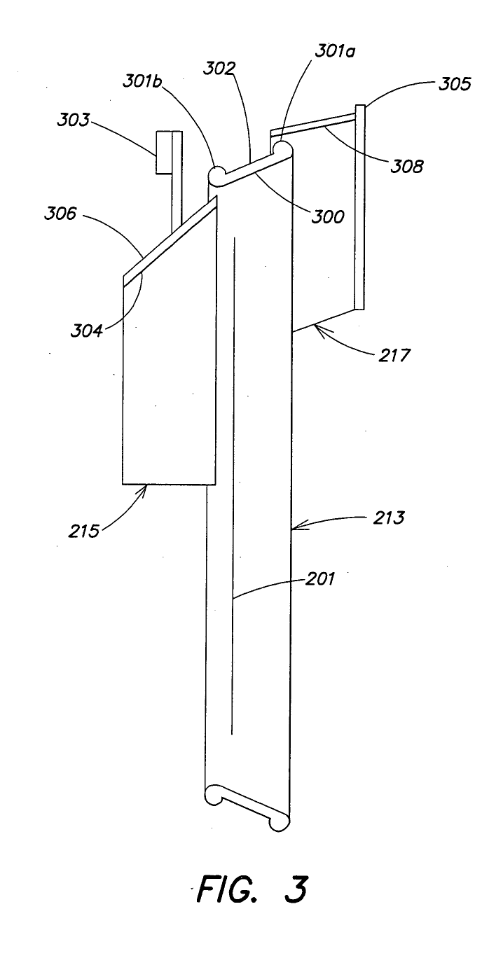

A shield system comprising a main shield 213, a lower shield 215 and a higher shield 217 is employed within the housing 103 to receive fluid thrown from the substrate 201. The shield system is shown separately in FIG. 3 and is described in additional detail with reference thereto.

FIG. 3 is a side cross-sectional view of the shield system of the SRD of FIG. 1. In one embodiment, the main shield 213 takes the form of a slice of a cone which may surround all or part of the perimeter of the substrate 201 positioned on the flywheel 205 (FIG. 2, not shown in FIG. 3), and may have a downwardly sloped cross section, as shown. Thus, the main shield 213 slants from a larger diameter to a smaller diameter (e.g., closest to the flywheel 205). These diameters preferably are selected such that the substrate-facing surface 300 of the main shield 213 has an angle in the range of 5° to 45° (from normal). In one embodiment of the main shield 213, the angle of the substrate-facing surface 300 is 18° from normal. In accordance with the invention, at least a portion of the substrate-facing surface 300 of the main shield 213 has a particle-blasted finish so as to have a hydrophilic characteristic, such that fluid displaced from the substrate 201 which strikes the substrate-facing surface 300 of the main shield 213 flows therealong deterring droplets from forming and dripping on the substrate 201. Details of the treatment of the substrate-facing surface 300 of the main shield 213 will be described below.

In one embodiment of the invention, the substrate-facing surface 300 and an outer surface 302 of the main shield 213 are parallel, such that the outer surface 302 and the substrate-facing surface 300 share a common downward slope. The outer surface 302 of the main shield 213 may have raised regions 301a, 301b along respective edges thereof to prevent rinsing fluid from running over the respective edge of the outer surface 302 of the main shield 213 and falling onto the substrate 201 positioned below an upper portion of the main shield 213.

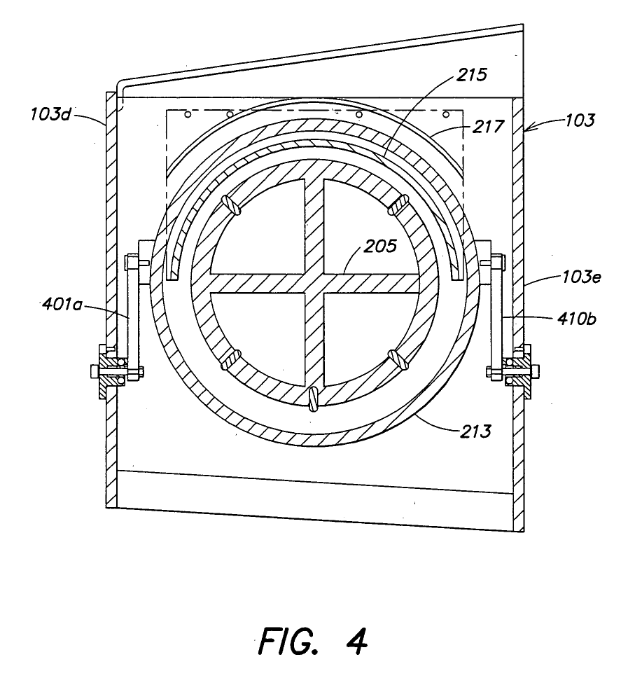

During processing of a substrate 201 in the SRD 101, the main shield 213 is positioned as shown in FIGS. 2 and 3. However, it will be observed that in the position shown in FIGS. 2 and 3, a portion of the main shield 213 is above the substrate 201, and so obstructs a path by which the substrate 201 is inserted through the opening 118 (FIG. 1) for placement on the flywheel 205. Accordingly, the main shield 213 is movable from the position shown in FIGS. 2 and 3 to another position (not shown) in which the main shield 213 does not obstruct placement of the substrate 201 on the flywheel 205 (or removal of the substrate 201 from the flywheel 205). As shown in FIG. 4, the main shield 213 is movable between the two positions discussed above by virtue of being mounted to the housing 103 via a pair of pneumatically driven links 401a and 401b. In particular, the main shield 213 is coupled to the first side wall 103d via the pneumatically driven link 401a, and is coupled to the second side wall 103e via the pneumatically driven link 401b. The main shield 213 may move uniformly forward, or the upper portion of the main shield 213 may tilt forward or backward, for example.

Referring again to FIG. 3, the lower shield 215 provided in accordance with one embodiment of the invention may also take the form of a cone-shaped slice. In the example shown, the lower shield 215 surrounds only the upper half of the perimeter of the substrate 201, although other configurations may be employed. The lower shield 215 may slant from a larger radius to a smaller radius with the larger radius being closer to the main shield 213 and the smaller radius being farther from the main shield 213. These radii may be selected such that the substrate-facing surface 304 of the lower shield 215 has an angle in the range of 5 to 45° (and in one embodiment 360) so that rinsing fluid flows therealong away from the substrate 201. The substrate-facing surface 304 of the lower shield 215 may, like the substrate-facing surface 300 of the main shield 213, have a particle-blasted finish so as to have a hydrophilic characteristic. An inventive treatment for causing the substrate-facing surface 304 to have a hydrophilic characteristic is described below.

The substrate-facing surface 304 and an outer surface 306 of the lower shield 215 may be parallel in one embodiment of the invention. The lower shield 215 may be coupled to the back side 103b (FIG. 2) of the housing 103 via a bracket 303 (FIG. 3).

Like the main shield 213 and the lower shield 215, the higher shield 217 may be described as a cone-shaped slice (e.g., having a downwardly sloped cross section), which, in the example shown, surrounds the upper quarter of the perimeter of the substrate 201. The higher shield 217 slants from a larger radius to a smaller radius which may be closest to the flywheel 205 (FIG. 2). These radii may be selected such that the substrate-facing surface 308 of the higher shield 217 has an angle in the range of 5° to 45°, and in one embodiment 100, so that rinsing fluid flows therealong toward the main shield 213 (as further described below). The substrate-facing surface 308 of the higher shield 217 also may have a particle-blasted finish so as to have a hydrophilic characteristic.

It will be observed that the substrate-facing surfaces 300, 304, 308 as illustrated in the drawings are concave, and that the higher shield 217 may be coupled to the front side 103a (FIG. 2) of the housing 103 via a bracket 305 (FIG. 3).

The main shield 213, the lower shield 215 and the higher shield 217 are arranged in a vertically and horizontally staggered manner to receive fluid displaced from the substrate 201 and the flywheel 205 (FIG. 2) as the flywheel 205 rotates with the substrate 201 supported thereon. The shields 213, 215 and 217 are adapted to carry fluid away from the region above the substrate 201. In one embodiment, the lower elevation (or small diameter) edge of the higher shield 217 overlaps the higher elevation (or larger diameter) edge of the main shield 213, and the lower elevation edge of the main shield 213 overlaps the higher elevation edge of the lower shield 215, as shown. The edges of the adjacent shields may be closely spaced vertically (e.g., 0.3 inches) so that in the regions above the substrate 201, fluid flows from the substrate-facing surface 308 or 300 of the shields 217, 213 respectively to the outer surface 302 or 306 of the shields 213, 215 respectively, with minimal splashing. The close vertical spacing of the shields 213, 215 and 217 may also facilitate transfer of fluid along the shield system (as further described below with respect to the overall operation of the SRD 101).

As previously noted, instead of the higher and lower shields 217 and 215 extending around only the top portion of the substrate 201, either or both can extend to surround any portion of, or the entire perimeter of the substrate 201. It should also be understood that instead of the main shield 213 extending entirely around the perimeter of the substrate 201, the main shield 213 may extend only along an upper portion of the substrate 201.

An inner surface of the sloping top 103c (FIG. 1) of the housing 103 may have a particle-blasted finish so as to have a hydrophilic characteristic that deters droplets from forming on the lower surface of the top 103c and falling therefrom. Likewise, an inner surface of the door 120 may be particle-blasted. A process for fabricating a shield having a particle-blasted finish is described below. Initially, a shield is formed (e.g., via a vacuum forming process) of an easily abraded yet rigid material such as a polycarbonate or the like. The shield is formed so as to have a suitable shape and size for installation in an SRD housing (e.g., such as one of the shields 213, 215 or 217). Thus, the shield may have a concave surface which is adapted to be a substrate-facing surface and to receive fluid displaced from a substrate that is held and rotated in the SRD housing.

Next the concave surface of the shield is particle-blasted so that the concave surface has a hydrophilic characteristic. As used herein a surface has a “hydrophilic characteristic” if an aqueous fluid (i.e., a fluid that is primarily comprised of water, such as pure deionized water (DIW) or extremely diluted fluids, for example a surfactant solution comprising over 90% DIW and preferably at least 98% DIW) in contact with the surface tends to form a sheet rather than discrete drops or droplets. An exemplary particle-blasting process that creates a polycarbonate shield having a hydrophilic characteristic may include grit-blasting using a blasting medium such as silicon carbide 100 black carbon, Anisgrade, available as part no. SC100BEX, from USF Surface Preparation. Grit-blasting with this medium may be performed at an air pressure in the range 75 to 80 pounds per square inch, with a nozzle distance from the concave surface of approximately six inches. In one embodiment of the invention, the nozzle is continuously moved during the grit-blasting operation to prevent excessive erosion of the concave surface. The grit-blasting may be applied to all or a part of the concave surface, and may result in a surface finish, for example, of about RA 60-75.

After the grit-blasting of the concave surface, the shield may be cleaned in a conventional manner (e.g., with deionized water).

As a result of the grit-blasting, the substrate-facing surface of the shield will have a hydrophilic characteristic such that a contact angle between fluid on the surface and the surface itself is increased, thereby promoting sheeting of the fluid and preventing formation of droplets that might otherwise fall on the substrate.

Similarly, the inner surface of the top 103c of the housing 103 and/or of the door 120 may be grit-blasted or otherwise particle-blasted so that the inner surface of the top 103c has a hydrophilic characteristic and thereby encourages sheeting and flowing of fluid along the top 103c to the second side wall 103e of the housing 103 and to discourage formation of droplets on the inner surface of the top 103c and/or on the door 120.

In an alternative embodiment of the invention, surface features are formed in at least the substrate facing surface of a shield, or in the inner surface of the SRD housing's top and/or in the door of the housing top. The features increase surface area, creating more area along which fluid may flow, and thus deterring drop formation (e.g., surface features may have generally smooth edges and low profiles so as not to form an obstacle that might deter fluid flow). Preferably the features also are shaped so as to direct or channel fluid from an apex of the featured surface. Such directing or channeling shapes will be both non-obstructive to fluid flow (e.g., smooth and having low profiles) and will extend along a downward slope (e.g., along the shield's sloped cross section, along the shield's circumference, which in a vertically oriented shield slopes downwardly or along a slope of a top portion or door of an SRD). Preferably at least a portion of a shield that is at a higher elevation than a substrate, or is directly above a substrate has the inventive featured configuration described above. A non-substrate facing surface of a shield may also include the features described above. Superior results have been achieved by employing a surface that is both particle-blasted and has the above described features formed therein.

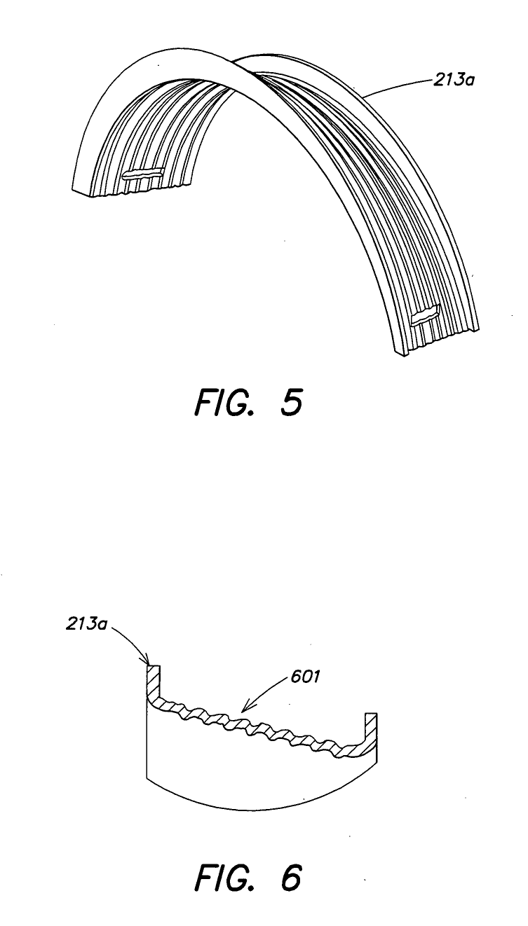

FIG. 5 is a partial isometric view of an exemplary main shield 213a provided in accordance with the alternative embodiment of the invention, and FIG. 6 is a partial cross-sectional view of the alternative main shield 213a. As best seen in FIG. 6, the alternative main shield 213a may have, for example, a rippled configuration (as indicated at 601), such as the sinusoidal configuration shown. Note that the exemplary sinusoidal configuration will direct fluid away from the apex of the featured surface. Other configurations such as chevron patterns, grooves or ribs that similarly extend along a downward slope will also serve to direct fluid therealong. In addition, the substrate-facing surface of the alternative main shield 213a may be particle-blasted so as to have a hydrophilic characteristic. The presence of the rippled configuration in the alternative main shield 213a increases the surface area of the substrate-facing surface, thereby increasing the capacity of the substrate-facing surface for flowing fluid away from the substrate 201. As an alternative to the parallel channels of the sinusoidal rippled configuration shown in FIGS. 5 and 6, the main shield may be provided with other feature configurations (not shown) to aid in flowing of fluid away from the substrate 201 (e.g., a chevron pattern which may be arranged to form channels, on an all over pattern of small features, etc.). Although the exemplary featured surface is shown on the main shield of a shield system, it will be understood that it may be employed on any shield, or on any surface where fluid droplets may otherwise form.

In operation of the SRD 101 of FIGS. 1-4, the slideable door 120 slides along the tracks 123a, 123b to an open position wherein the opening 118 is exposed, as shown in FIG. 1. The flywheel 205 is positioned and configured (e.g., in a manner described in the above-referenced '660 application) to receive the substrate 201. A substrate handler (not shown) lowers the substrate 201 through the opening 118 and transfers the substrate 201 to the flywheel 205. The substrate 201 is secured to the flywheel 205 (for example, as described in the above-referenced '660 application). Thereafter, the flywheel 205 begins to rotate. The flywheel 205 may initially rotate at a relatively slow speed (e.g., 100 to 500 revolutions per minute (rpm)) while the rinsing fluid nozzles 208a, 208b supply rinsing fluid to the center of the front and back surfaces of the substrate 201. After the substrate 201 is sufficiently rinsed, the motor 207 may increase the rotational speed of the flywheel 205 (e.g., to approximately 1000 to 2500 rpm) such that rinsing fluid is displaced from the substrate 201 via the increased rotational speed.

During both the rinsing and drying steps, rinsing fluid may be flung from the substrate 201 to the substrate-facing surfaces 300, 304, 308 (FIG. 3) of the shield system. The majority of the fluid is received by the main shield 213, but fluid may also land on the lower shield 215, the higher shield 217, and the lower unshielded portions of the housing 103 or may condense on the lower surface of the top 103c of the housing 103.

In one embodiment, the main shield 213 may be angled such that fluid which impacts the main shield 213 is at least partially reflected therefrom toward the front side 103a of the housing 103 and therefore does not collect on the main shield 213. Further, part or all of the substrate-facing surfaces 300, 304, 308 of one or more of the shields 213, 215 and 217 have been particle blasted in accordance with the invention so as to have a hydrophilic characteristic, so that fluid which is not reflected therefrom travels therealong in a sheet, rather than forming droplets which may fall onto the substrate 201. Fluid may flow along the downwardly sloped cross section of the substrate-facing surface 308 of the higher shield 217 to the top/non-substrate-facing surface 302 of the main shield 213.

Fluid may travel from the non-substrate-facing surface 302 of the main shield 213 to the non-substrate-facing surface 306 of the lower shield 215 and from the non-substrate-facing surface of the lower shield 215 to the back side 103b of the housing 103. The rinsing fluid may then flow along the back side 103b of the housing 103 to the bottom 103f of the housing 103 where fluid may be removed by a pump, which is not shown.

Similarly, fluid may flow from the substrate-facing surface 300 of the main shield 213 to the non-substrate-facing surface 306 of the lower shield 215. In one aspect, due to the relatively steep angle of the lower shield 215, any fluid that lands on either the substrate-facing surface 304 or the non-substrate-facing surface 306 of the lower shield 215 flows quickly to the back side 103b of the housing 103. Note that any of the shields 213, 215, 217 may have a featured surface that increases surface area and deters drop formation as previously described. If the featured surface is adapted to direct fluid flow, the featured surface may, for example, have features that direct the fluid along a downward slope of a substrate facing surface and/or along a downward slope of a non-substrate facing surface of a shield, such that the fluid flows from the substrate-facing surface of one shield to the non-substrate facing surface of the next lower shield as previously described. A shield that has surface features that direct fluid along a downward slope of the shield's cross section is shown in the partial isometric view of FIG. 6.

If, however, the surface features are adapted to direct fluid along the inner or outer circumference of the shield (as shown in FIGS. 5 and 6), the fluid may flow circumferentially along the shield rather than along the shield's downwardly sloped cross section, and/or may flow both circumferentially and along the downwardly sloped cross section (e.g., in a diagonal manner, as generally represented by arrow A on FIG. 5).

Any fluid which reaches the top 103c of the housing 103 will tend to flow therealong, due to the slope of the top 103c, to the second side wall 103e of the housing 103. In at least one embodiment of the invention, the inner surface of the top 103c of the housing 103 and/or the door 120 may have been particle-blasted in accordance with the invention so as to have a hydrophilic characteristic, to promote sheeting of fluid on the inner surface of the top 103c and the door 120, and to tend to prevent formation of fluid droplets thereon. However, should fluid droplets form on the inner surface of the top 103c of the housing 103 and the door 120, the droplets will fall onto the non-substrate-facing surfaces of the shield system and travel therealong, rather than contacting the substrate 201. Either the inner is surface of the top 103c or the door 120 may have features formed thereon to increase surface area and optionally to direct fluid flow, regardless of whether or not these surfaces are also particle-blasted.

As the substrate 201 rotates, fluid flows along the surface of the substrate 201, rinsing residue therefrom. Drying of the substrate 201 may be aided by a heating system and/or a gas flow system, which are not shown herein, but are disclosed in the above-referenced '660 patent application. After the substrate 201 is sufficiently dry, the motor 207 slows and then stops the rotation of the flywheel 205. The grippers which grip the substrate 201 to the flywheel 205 then release the substrate, the door 120 slides open and a substrate handler (not shown) extracts the rinsed and dried substrate 201 from the SRD 101.

The inventive particle-blasted components may be inexpensive to manufacture and provide superior fluid shielding.

The foregoing description discloses only exemplary embodiments of the invention; modifications of the above-disclosed apparatus and method which fall within the scope of the invention will be readily apparent to those of ordinary skill in the art. For instance, the shield system may include one or any number of shields. The shield system may be angled so as to direct fluid to the front side, or to the first or second side walls of the SRD housing. The substrate-facing and non-substrate-facing surfaces of each shield need not be parallel. Neither is it required that the shield or shields of the shield system be cone-shaped, nor that the substrate-facing surfaces be shaped as shown. Although the shield system has been disclosed in connection with an SRD in which a single substrate is processed at a given time, it may also be applied in an SRD in which a batch of two or more substrates is processed at once. Also, although the present invention has been illustrated with respect to a vertical SRD (i.e., an SRD in which the substrate is spun and rinsed in a vertical orientation), it may be employed to an SRD in which the substrate is spun and rinsed in a horizontal orientation or another orientation other than vertical.

The present invention may be applied in SRD's used for rinsing and drying silicon wafers and/or in SRD's used for processing other types of substrates.

The invention has been described in connection with an embodiment in which grit-blasting is employed to cause the substrate-facing surface of a shield or shields to have a hydrophilic characteristic. However, other types of particle-blasting, such as sand-blasting or bead-blasting, or the like, may also or alternatively be employed. Moreover, all or a part of the substrate-facing surface of a shield may be particle-blasted. Accordingly, as used herein and in the appended claims, a particle-blasted surface includes a surface of which all or a part has been particle-blasted. The surface may be comprised of a hydrophilic material (e.g., coated with a hydrophilic material, having a hydrophilic material insert, or made of a solid hydrophilic material), and the hydrophilic characteristic may be increased by particle-blasting.

As noted above, the present invention may be applied in a shield system for an SRD wherein one, two or more shields are included in the shield system. If two or more shields are included in the shield system any one or more of the shields may have a substrate-facing surface having a particle-blasted finish. Furthermore, the non-substrate-facing surface of one or more of the shields may be particle-blasted. Also, the inner surface of the top of the SRD housing and/or the door may or may not be particle-blasted in accordance with the invention regardless of whether or not a shield having a particle-blasted surface finish is employed.

Although the mounting brackets 303, 305 (FIG. 3) have been referred to separately from their respective shields 215, 217, one or both of the brackets 303, 305 may be integrally formed with the respective shield 215 or 217.

Accordingly, while the present invention has been disclosed in connection with exemplary embodiments thereof, it should be understood that other embodiments may fall within the spirit and scope of the invention, as defined by the following claims.

The invention claimed is:

1. An SRD, comprising:
a substrate support adapted to hold and rotate a substrate;
a source of fluid adapted to supply fluid to a surface of a substrate positioned on the substrate support; and
a shield positioned to receive fluid displaced from a substrate rotating on the substrate support, and comprising a substrate-facing surface at least a portion of which has a particle-blasted finish.

2. The SRD of claim 1, wherein the particle-blasted finish has a hydrophilic characteristic.

3. The SRD of claim 2, wherein the substrate support holds and rotates the substrate in a vertical orientation.

4. The SRD of claim 3, wherein at least part of the shield is at a higher elevation than the substrate support.

5. The SRD of claim 4, wherein at least part of the particle-blasted finish is above the substrate when the substrate is held and rotated by the substrate support.

6. The SRD of claim 4, wherein the shield is movable between a first position in which at least part of the shield is above the substrate when the substrate is held and rotated by the substrate support and a second position in which the shield does not obstruct placement of the substrate on the substrate support from a position above the substrate support.

7. The SRD of claim 4, wherein the particle-blasted finish has a downwardly sloped cross section.

8. The SRD of claim 7, wherein a top surface of the shield has a downwardly sloped cross section.

9. The SRD of claim 1, wherein the shield comprises polycarbonate.

10. The SRD of claim 9, wherein the shield is a unitary piece of molded polycarbonate.

11. The SRD of claim 9, wherein the particle-blasted finish is a grit-blasted finish.

12. The SRD of claim 1, wherein the shield is a unitary piece of molded polycarbonate.

13. The SRD of claim 4, wherein the substrate-facing surface has surface features for directing fluid from an apex of the shield.

14. The SRD of claim 4, wherein the substrate-facing surface has a plurality of channels configured to direct fluid circumferentially along the shield.

15. The SRD of claim 4, wherein the particle-blasted finish has a downwardly sloped cross section and wherein the channels are configured to direct fluid along the downwardly sloped cross section.

16. A vertical SRD, comprising:
a substrate support adapted to hold and rotate a vertically oriented substrate;
a source of fluid adapted to supply fluid to the surface of a substrate positioned on the substrate support; and
a shield system comprising a plurality of vertically and horizontally staggered shields positioned to receive fluid flung from a substrate rotating on the substrate support, at least one of the shields having a substrate-facing surface that has a particle-blasted finish.

17. The SRD of claim 16, wherein the plurality of shields includes:
a main shield wherein the substrate-facing surface is angled from a higher elevation closest to a first side of the substrate to a lower elevation closest to a second side of the substrate so that the fluid flows therealong to a lower edge of the main shield;
a lower shield positioned at a lower elevation than the main shield, extending from a point beneath the main shield to a point beyond the lower edge of the main shield, and being angled from a higher elevation closest to the lower edge of the main shield, to a lower elevation farthest from the main shield; and
a higher shield positioned at a higher elevation than the main shield, extending from a point above the main shield to a point beyond the higher edge of the main shield and being angled from a lower elevation closest to the higher edge of the main shield, to a higher elevation farthest from the main shield.

18. The SRD of claim 16, wherein at least a portion of the at least one particle-blasted finish has a hydrophilic characteristic.

19. A vertical SRD, comprising:
a substrate support adapted to hold and rotate a vertically oriented substrate;
a source of fluid adapted to supply fluid to the surface of a substrate positioned on the substrate support; and
a housing which encloses the substrate support, the housing having a top portion that has a slope adapted to cause fluid to flow therealong away from a region above the substrate support, the top portion having a lower surface that has a particle-blasted finish.

20. The SRD of claim 19, wherein at least a portion of the lower surface of the top portion has a hydrophilic characteristic.

21. A method of fabricating a component of an SRD, the method comprising:
forming a shield adapted to fit in an SRD housing and having a concave surface adapted to receive fluid displaced from a substrate held and rotated in the housing; and
particle-blasting the concave surface of the shield.

22. The method of claim 21, wherein the particle-blasting step is performed so as to impart a hydrophilic characteristic to the concave surface of the shield.

23. The method of claim 21, wherein the particle-blasting step includes grit-blasting the concave surface of the shield.

24. The method of claim 21, wherein the forming step includes molding a polycarbonate material.

25. A shield for at least partially surrounding a substrate to be spin dried, the shield comprising:
a concave surface adapted to extend at least partially around a perimeter of a semiconductor substrate and to face toward the semiconductor substrate, and having a particle-blasted finish that exhibits a hydrophilic characteristic.

26. The shield of claim 25 wherein the concave surface has a plurality of surface features formed therein so as to increase surface area.

27. The shield of claim 26 wherein the surface features are further adapted to direct fluid from an apex of the shield, when the shield is vertically oriented.

28. The shield of claim 27 wherein the concave surface has a sloped cross section and the surface features are adapted to direct fluid along the sloped cross section.

29. The shield of claim 27 wherein the surface features are adapted to direct fluid circumferentially along the concave surface.

30. The shield of claim 27 wherein the surface features have a sinusoidal cross section.

31. A shield for at least partially surrounding a substrate to be spin dried, the shield comprising:
a concave surface adapted to extend at least partially around a perimeter of a semiconductor substrate and to face toward the semiconductor substrate, and having a plurality of surface features formed therein so as to increase surface area.

32. The shield of claim 31 wherein the surface features are further adapted to direct fluid from an apex of the shield, when the shield is vertically oriented.

33. The shield of claim 32 wherein the concave surface has a sloped cross section and the surface features are adapted to direct fluid along the sloped cross section.

34. The shield of claim 32 wherein the surface features are adapted to direct fluid circumferentially along the concave surface.

35. The shield of claim 34 wherein the surface features have a sinusoidal cross section.
